(19) United States
(12) Patent Application Publication
(10) Pub. No.: US 2012/0058881 A1
(43) Pub. Date: Mar. 8, 2012

(54) CERAMIC PRODUCT

(76) Inventors: Josef Suren, Bad Wunnenberg-Haaren (DE); Peter Stracke, Iserlohn (DE); Christos Aneziris, Freiberg (DE); Steffen Dudczig, Grosshartmannsdorf (DE)

(21) Appl. No.: 13/202,076

(22) PCT Filed: Feb. 8, 2010
(86) PCT No.: PCT/EP2010/000758

§ 371 Date: Nov. 21, 2011

(30) Foreign Application Priority Data
Feb. 20, 2009 (EP) 09002411.8

(51) Int. Cl. C04B 35/563; C08K 3/22; C08K 3/38; C08K 3/34; C08L 61/12; C04B 35/462; C04B 35/505; C04B 35/50; C04B 35/565; C04B 35/584; C04B 35/583; B29C 41/42; C04B 35/01

(52) U.S. Cl. 501/88; 264/334; 524/430; 524/404; 501/1; 501/153; 501/152; 501/134; 501/96.4; 501/97.4; 501/87

(57) ABSTRACT

The invention relates to a ceramic product, manufactured from a mixture made of natural and/or synthetic inorganic non-metal raw materials, at least one binder and optionally further additives. In order to provide ceramic products allowing for disadvantages known from the prior art to be eliminated, at least with respect to corrosion and erosion, it is proposed that the ceramic products are manufactured from a mixture comprising a) at least 10% by weight (based on the weight of all solids of the mixture) oxidic components, b) 0.05 to 2.7% by weight (based on the weight of all solids of the mixture) at least one organic-based binder, acting as a solubilizer in the mixture, and c) 3 to 10% by weight (based on the weight of all solids of the mixtures) hydrous dispersing agent, and that the ceramic product contains less than 0.1% by weight (based on the total weight of the ceramic product) of carbon after the use thereof at temperatures above 600° C.

This application claims the benefit of PCT Application PCT/EP2010/000758 with International Filing Date of Feb. 8, 2010, published as WO 2010/094410 A1, which further claims priority to European Patent Application No. 09002411.8 filed Feb. 20, 2009, the entire contents of both are hereby incorporated by reference.

The invention relates to a ceramic product produced from a mixture of natural and/or synthetic inorganic nonmetallic raw materials, at least one binder and optionally further additives.

Ceramic products have a softening point above 1000° C. and are therefore widely used, e.g. as refractory compositions in linings in metallurgical vessels or as key components such as submerged nozzles, slider plates, plugs or pouring spouts in the continuous casting sector. Refractory products (softening point above 1500° C.) are also used in the blast furnace sector, in metallurgical transport vessels, in the domestic waste incineration industry, in the cement industry and in the chemical industry as lining material.

Refractory products are classified on the basis of the process technology into shaped compositions (shaped bodies) and unshaped compositions, i.e. shaping occurs during use.

The field of unshaped refractory compositions has gained considerably in importance in the last 30 years. With a proportion of virtually 45% of the total production of refractory construction materials, they represent an important group of refractory ceramics. The most important group of unshaped refractory compositions is refractory castables. The unshaped refractory compositions are nowadays largely high-quality, defined materials which are not at all inferior to the shaped refractory products in terms of quality.

The refractory compositions comprise a mixture of particulate refractory mineral oxidic and/or nonoxidic raw materials (e.g. oxides: Al₂O₃, MgO, MgAl₂O₄, CaO, ZrO₂, Cr₂O₃, CeO₂, Y₂O₃, TiO₂ or raw materials in which these are present, e.g. bauxite, andalusite, dolomite, chamotte, and nonoxides: for example SiC, Si₃N₄, BN, B₄C) having a generally defined particle size distribution matched to the respective processing method. Since these mixtures are loose particle mixtures, they have to be admixed with suitable binders or binder combinations in order to ensure sufficient strength of the materials in all technological process steps such as production, heating and use. The binders used are reactive materials which cure automatically under the action of water, air and/or heat. Furthermore, unshaped refractory compositions contain further materials such as plasticizers or additives.

The most frequently used binder is cement based on calcium aluminates, the high-alumina cements, which allow strengthening of the refractory product as a result of hydration processes (hydraulic binding). However, if the refractory composition contains calcium oxide, which is usually the case, the materials properties can be impaired because of formation of undesirable phases which ultimately worsen or reduce the properties and the use temperatures of the refractory composition. Owing to these adverse effects, there have been many developments with the aim of reducing or completely eliminating high-alumina cements.

The earlier classical refractory castables were produced with a proportion of 15-20% of high-alumina cement. Here, the limiting use temperature was restricted to a region of about 1500° C., since formation of low-melting compounds occurs as a result of reactions between binder constituents and the particulate material. Owing to these phenomena, low-cement refractory castables were developed. In this technology, lower cement contents are made possible by the use of fine fillers such as microsilica in combination with plasticizers. These low-cement refractory castables display higher strengths owing to the optimized particle packing, a considerable reduction in the strength minimum and a high density, associated with a lower and finer porosity. However, the low-cement refractory castables developed are more sensitive to drying and heating because of their lower porosity. In recent years, the use of hydratable transition aluminas has in some applications become established as an alternative to hydraulic high-alumina cement binding. In the case of this binder, the adverse effect of the calcium oxide is ruled out.

A further group of binders comprises chemical-inorganic materials. This binding is used for plastic compositions and also tamping compositions, casting compositions and gunning compositions. Use is frequently made of water glasses based on alkali metal silicate solutions for the use range 100-1000° C. and phosphate compounds, frequently aluminum phosphate, for a higher temperature range up to 1600° C. The chemical binding displays a very good adhesive effect and the absence of a strength minimum. However, the chemistry of the binder system used can lead to undesirable lowering of the limiting use temperature. Furthermore, interactions with materials present in the surroundings, for example as a result of phosphate evaporation, cannot be ruled out in the case of the chemically bonded systems.

Organic binding of refractory compositions in the form of waste sulfide liquors, methylcelluloses, alginates, ethyl silicates, tetraethoxysilane and further macro-molecular substances also gives acceptable strength values in many cases. However, in the case of these systems, too, limiting of the applications due to undesirable reactions caused by compounds introduced cannot be ruled out in many cases. Here too, the chemical compounds added sometimes also restrict the possible uses or limit the amount of binder possible. In many cases, e.g. in the case of waste sulfite liquors and celluloses, the organic binding can be considered to be a temporary binder since it burns out leaving virtually no residue on heating above a particular temperature range and its binder action is therefore only temporary. However, in some cases, e.g. in the case of ethyl silicates, part of the binder system can also be retained, in the example mentioned the silicon dioxide, and thus continue to have a binder action.

In the case of the unshaped products, in particular the hydraulically bound materials, drying and heating are a frequently problematical process step since relatively high residual moisture contents have to be removed from a relatively dense microstructure. This leads, depending on formation of the monolithic structure or size of the component produced, to very long drying times and incurs the risk of drying cracks and thus damage to the lining or the prefabricated components before use. During the first heating of monolithic products, it also has to be taken into account that these very frequently have a strength minimum in the range from 300 to 900° C. This minimum is in the temperature range between the dewatering of the hydrate phases and the formation of the ceramic bond of the material. The dehydration of the binder phases causes a loss in binding strength. An increase in the strength occurs only at the commencement of formation of the ceramic bond as a result of sintering processes above about 1000° C.

The processing or shaping and the heat treatment of the unshaped refractory compositions is usually carried out at the site of use or under use conditions. Processing is carried out directly in the as-delivered state or after addition of a required amount of liquid. These compositions are installed by means of vibration, casting without vibration (self-compacting compositions), by rodding, tamping or spraying. The binding and curing of the compositions usually occurs without heating. Setting of the refractory compositions forms linings which, compared to masonry, have a monolithic, i.e. joint-free, structure and appearance.

The production of shaped refractory compositions is carried out by introducing the raw composition into shape-imparting structures, e.g. for the production of refractory tubes or bricks, these are taken from the mold and the water is withdrawn from them in a drying process of a number of days at from about 200 to 700° C. This process is very time-consuming, requires a large amount of water to achieve sufficient flowability, and this in turn leads to a correspondingly long drying process. However, if the heating process is accelerated, drying cracks and spalling in the finished product are the consequences.

It is known from EP 0 577 733 B1 that refractory compositions can be produced from magnesia, calcium oxide, aluminum oxide, aluminum oxide silicates, magnesia spinels, aluminum oxide spinels and mixtures thereof, with from 5 to 10% by weight of a specific liquid resol-phenolic ester curable resin and an ester as hardener. However, inhomogeneities occur in these compositions due to the high viscosity during production. Furthermore, depending on the use, a high proportion of residual carbon remains in the composition. This residual carbon (as in the case of graphite-containing mixtures, too) can be burnt out during use of the refractory composition, which leads to a higher porosity of the refractory product. Liquid iron, for example, can then penetrate into these pores on contact with said iron, which ultimately leads to a reduction in the durability of the refractory product. Furthermore, the carbon burnt out is absorbed by the liquid iron, which leads to a reduction in quality of the steel to be produced, in particular stainless steel.

Furthermore, EP 0 530 943 B1 discloses a process for producing a refractory composition in which a delay in the curing is achieved in the case of compositions containing hard or dead-burned magnesia by the use of at least 3% by weight of a curable phenolic resin and of compounds which release asparate, fluoride, bifluoride, malate, tatrate, citrate, phosphonate ions and contain a specific tetraalkoxysilane.

However, it has been found that the composition indicated led to high viscosities occurring during production. These are unfavorable from a processing point of view since the shape-imparting surroundings are not completely filled.

JP 07330451-A, JP 05070246-A and JP 2008-0249, too, mention refractory compositions containing mineral constituents, synthetic resins as binders and further organic additives. The properties are influenced in various ways as a result.

It is thus an object of the present invention to provide ceramic products which make it possible to eliminate the disadvantages known from the prior art, at least in respect of corrosion and erosion.

This object is achieved according to the invention by the ceramic product being produced from a mixture of natural and/or synthetic inorganic nonmetallic raw materials, at least one binder and optionally further additives, wherein the mixture comprises
a) at least 10% by weight (based on the weight of all solids of the mixture) of oxidic constituents,
b) from 0.05 to 2.7% by weight (based on the weight of all solids of the mixture) of at least one organic-based binder which has a plasticizing effect on the mixture and
c) from 3 to 10% by weight (based on the weight of all solids of the mixture) of a water-containing dispersion medium
   and the ceramic product after use at temperatures above 600° C. contains less than 0.1% by weight (based on the total weight of the ceramic product) of carbon.

It has surprisingly been found that the mixture has a low viscosity which is favorable in terms of processing in the production of the ceramic product according to the invention, so that additional plasticizers, whose provision is associated with additional costs and which can in turn influence other properties, can be dispensed with. A low viscosity of the mixture results in the shaping surroundings being well filled as a result of the good flowability and a high-quality ceramic product thus being produced. In addition, a smaller amount of water is required during production of the ceramic product, as a result of which drying times are shortened and drying cracks and spalling in or on the ceramic product are avoided.

The ceramic products of the invention, which contain less than 0.1% by weight (based on the total weight of the ceramic product), preferably 0%, of carbon also have, in comparison with conventional refractory compositions which generally contain refractory castables, at least a higher cold bending strength and density after drying and a lower porosity after burning out. Furthermore, the ceramic products of the invention can be produced using conventional manufacturing technology, so that no additional outlay is required for this purpose. Thus, the finished components can be demolded, or monolithic structures can be removed from the formwork, in the same times. The subsequent drying step is less problematical since, according to the invention, no hydrate phases which could lead to increased elimination of water in specific temperature ranges are formed. As drying aids, it is possible, as in the case of conventional compositions having hydraulic binding, to add fibers (e.g. natural fibers, synthetic fibers) to form channels for the escape of physically bound water. Furthermore, it is possible to add metallic and/or nonmetallic fibers to reinforce the microstructure during drying, heating and use. Furthermore, the mixtures of the invention no longer have any effect on the quality of the steel because of their very low carbon content (or preferably freedom from carbon).

As natural and/or synthetic inorganic nonmetallic raw materials, preference is given to using Al₂O₃, MgO, SiO₂, CaO, ZrO₂, Cr₂O₃, CeO₂, Y₂O₃, TiO₂ and/or, for example, MgAl₂O₄, spinel, forsterite, bauxite, andalusite, dolomite and/or chamotte as raw materials containing oxidic constituents. Furthermore, it is also possible to use nonoxidic raw materials as natural and/or synthetic inorganic nonmetallic raw materials, preferably BN, SiC, Si₃N₄, B₄C or else TiN and/or TiC. However, other natural and/or synthetic inorganic nonmetallic raw materials known from the prior art are also conceivable.

According to the invention, the ceramic product contains at least 10% by weight (based on the weight of all solids in the mixture) of oxidic constituents (as indicated above).

If less than 10% by weight of oxidic constituents is used, the composition displays partial demixing of the solid particles and the dispersion medium.

Preference is given to using at least 10% by weight of oxidic constituents for the production of the ceramic product, since demixing and a tendency for the refractory particles to sediment is no longer observed above 10% by weight.

Particular preference is given to the ratio of the oxidic constituents to the nonoxidic constituents being from 80:20 to 50:50, which gives advantages in respect of the processability and also the high-temperature properties, e.g. the creep strength.

The mixes obtained from the abovementioned raw materials have a particle size distribution matched to the required processing methods, for example compaction by means of vibration, casting without vibration (self-compacting compositions), by rodding, tamping or spraying. The matching of the particle size distribution is effected with the aid of relevant theories, for example the Andreassen distribution. Here, the compositions are optimized in respect of an ideal distribution using a particle size distribution factor advantageous for the various processing technologies. The particle size distribution factor represents the gradient in a logarithmic plot of the cumulative particle size distribution. Thus, self-compacting compositions (compaction without external application of force) are in general designed with a particle size distribution factor in the range from 0.25 to 0.30 which is favorable for these compositions. In the case of vibration compositions, higher values for the particle size distribution factor in the range 0.30-0.35 are generally assumed. The compositions comprise the respective refractory oxides, natural or synthetic raw materials comprising compounds of the refractory oxides and/or mixtures of the materials mentioned in the fine particle, medium particle and coarse particle range. The particle size ranges encompass particles in the nanometer range up to the coarse particle range which can be up to 15 mm particle diameter. Finally, it can be said that a substitute is possible in all compositions which contain oxidic compounds or oxides as main components and are used in the prior art to date.

As organic-based binder, preference is given to using synthetically produced binders such as phenolic resins, epoxy resins, furan resins, amino resins, alkyd resins, resorcinol resins and/or aqueous dispersions of novolaks, resols and/or epoxy resins, acrylate dispersions and/or polyurethane dispersions and/or binders produced from natural raw materials such as sugar, glucose, polysaccharides, tannins and/or lignins. The natural raw materials are advantageous because of their renewable nature. Phenolic resins, furan resins, epoxy resins and amino resins can be cured at room temperature, which is a great advantage in this application. An additional hardener can therefore be dispensed with. When dispersions are used, it is advantageous for these to be low in monomer, have a low viscosity and be aqueous.

Particular preference is given to the use of aqueous phenolic resins since these can be cured with addition of a hardener at room temperature, the curing times can readily be varied and they generally do not contain any organic solvents.

To produce the ceramic product of the invention, the organic-based binder is added in a concentration of from 0.05 to 2.7% by weight (based on the weight of all solids of the mixture). If less than 0.05% by weight is added, no sufficient effect on strength and flow behavior is observed. In the case of concentrations above 2.7% by weight, it has surprisingly been found that the plasticizing effect of the binder on the mixture decreases, and the mixture may even no longer be flowable. Particular preference is given to the organic-based binder to be added in a concentration of from 0.5 to 2.0% by weight. The plasticizing effect is then greatest and the porosity after firing is lowest.

As further constituent, the mixture for producing the ceramic product of the invention contains a water-containing dispersion medium (in the simplest case water) in a concentration of from 3 to 10% by weight (based on the weight of all solids of the mixture). The water-containing dispersion medium reduces the viscosity, so that optimal processing of the mixture is ensured in this range.

It is also advantageous for the mixture to contain a hardener as further additive. This hardener is added in a preferred concentration of from 0.1 to 0.6% by weight (based on the weight of all solids of the mixture) since curing speed and resulting strengths correspond to those needed especially in this range. It is possible to use all hardeners known from the prior art which are suitable for the respective resins. The hardener is particularly preferably selected from among esters (low molecular weight lactones such as butyrolactone, caprolactone, propiolactone, pentyllactone, propylene carbonate, ethylene carbonate, etc.), acids (e.g. p-phenolsulfonic acid) or amines (e.g. polyamines (aliphatic, cycloaliphatic or aromatic), polyamides, Mannich bases, polyaminoimidazoline, polyether amines), but the hardener can be matched to the specific use of the resin.

Especially in the case of esters, the curing time can be matched exactly to the processing process.

However, it is generally also possible to dispense with the use of a hardener, in which case curing then takes place under the action of heat. This once again has the advantage that a component can be omitted, which is favorable in terms of costs and can be without effect on further properties of the mixture.

Further organic and/or inorganic additives which aid, for example, the plasticization and/or binder function of the mixture are conceivable but not necessary, so that the provision and the associated costs do not arise. Owing to the small number of components, any undesirable effect thereof on the properties of the mixture or the ceramic product is also avoided.

The ceramic product of the invention after use at above 600° C. contains less than 0.1% by weight (based on the total weight of the ceramic product) of carbon, with particular preference being given to the ceramic product of the invention containing no detectable carbon. The individual components of the mixture and the use parameters are accordingly selected, according to the invention, so that less than 0.1% by weight of carbon is present in the cured product.

The ceramic product of the invention can be produced by a process comprising the following steps:
a) production of the homogeneous mixture,
b) shaping of the mixture and drying and/or curing at above 15° C. and
c) optionally removal from the mold and further drying and/or curing at temperatures above 50° C.

To produce shaped and also unshaped products, the ceramic raw materials having an appropriate particle size distribution are homogeneously mixed with the appropriate amount of binder in a mixer, e.g. from Eirich.

In the case of production of unshaped compositions, the mixtures are then packed and transported to the place where they are to be used. The correct amount of hardener and water are added in a mixer on-site and the castable composition is then conveyed, e.g. pumped, to the apparatus to be lined. In the case of production of shaped products, the mixture of raw materials and binder is mixed directly with an appropriate amount of hardener and water in the mixer. The mixture is dried and partially cured in a mold until it has sufficient strength for removal from the mold. The shaped body is then either used directly or is subjected to a further heating process which can proceed at a temperature of 120-180° C. for a number of hours.

The ceramic products of the invention can, for example, be employed in apparatuses in the metallurgical industry.

The invention will be illustrated with the aid of an example.

The compositions indicated in Table 1 can be used for shaped products, e.g. oxygen lance nozzles, and/or unshaped refractory products, e.g. lining of a steel transport ladle. These are two mixes (mixes 2 and 3) containing the mixture according to the invention, a conventional system based on hydratable alumina (Alphabond 300, from Almatis) (composition mix 1) and a comparative composition mix 4. All four composition mixes are based on a matched mixture of aluminum oxide (tabular alumina T60/T64 from Almatis) and aluminum oxide rich magnesium aluminate spinel (AR78 from Almatis). Table 1 shows the compositions of four examples. The differences in the mixes are that the conventional mix (composition mix 1) contains not only the added binder Alphabond 300 (hydratable alumina) but also the additives ADW1 and ADS 1 (dispersing aluminas). In contrast, it can be seen that in the case of the other two mixes (composition mix 2 and composition mix 3) no Alphabond 300 and no additives ADW and ADS were added. The composition mix 2 contains 2% of the organic-based binder of the mix according to the invention and the composition mix 3 contains 1% of this binder.

TABLE 1
Composition mixes 1 to 4

| | | | | Comp. mix 2 | Comp. mix 3 | |
|---|---|---|---|---|---|---|
| | | | Comp. mix 1 | Invention | Invention | Comp. mix 4 |
| | | | [% by mass] | [% by mass] | [% by mass] | [% by mass] |
| Manufacturer: Almatis | Tabular Alumina | 2-5 mm | 25 | 25 | 25 | 25 |
| | T60/64 | 1-3 mm | 15 | 15 | 15 | 15 |
| | | 0.5-1 mm | 11 | 11 | 11 | 11 |
| | | 0-0.02 mm | 11 | 11 | 11 | 11 |
| | AR78 | 0-0.5 mm | 7 | 7 | 7 | 7 |
| | | 0-0.09 mm | 9 | 9 | 9 | 9 |
| | | 0-0.02 mm | 8 | 8 | 8 | 8 |
| | Reactive alumina | CTC50 | 10 | 13 | 13 | 13 |
| | | CT3000SG | 1 | 1 | 1 | 1 |
| | Binder | Alphabond | 3 | — | — | — |
| | | 300 | | | | |
| | | | 100% by mass | | | |
| | Additives | ADW1 | 0.5 | — | — | — |
| | | ADS1 | 0.5 | — | — | — |
| | Water | | 5.5 | 5.0 | 5.0 | 6.5 |
| | Resin* | | — | 2.0 | 1.0 | 3.0 |
| | Hardener** | | — | 0.3 | 0.15 | 0.45 |

*Phenolic resol having a free phenol content of less than 1%, viscosity 200-400 mPas at 20° C., resin content of 52-55%
**Mixture of butyrolactone and ethylene glycol diacetate in a ratio of 30:70

The composition mixes were mixed according to conventional concrete technology in a laboratory mixer from ToniTechnik and subsequently cast to produce test specimens having the dimensions 40×40×160 mm. These were removed from the mold after 3 hours, dried to constant mass at 120° C. Table 2 shows some materials properties of the specimens produced. Composition mix 4 was not pourable.

TABLE 2
Materials properties

| | | | Composition mix | Composition mix |
|---|---|---|---|---|
| Treatment | | Composition mix | 2 | 3 |
| temperature | Materials property | 1 | Invention | Invention |
| 120° C. | Apparent density | 2.90 | 2.97 | 2.95 |
| Drying | [g/cm³] | | | |
| | Cold bending strength | 3.20 | 5.53 | 4.63 |
| | [MPa] | | | |
| Firing | Apparent density | 3.05 | 2.91 | 3.04 |
| | [g/cm³] | | | |
| 1650° C. | Cold bending strength | 39.80 | 33.96 | 37.07 |
| | [MPa] | | | |
| | Dynamic E modulus | 69 | 63 | 85 |
| | [GPa] | | | |
| | Open porosity [%] | 17.1 | 15.4 | 15.4 |
| | Carbon content [%] | 0 | 0 | 0 |

The compositions according to the invention are insensitive to drying cracks and therefore also have higher green strengths and the lower porosities contribute to improved corrosion and erosion properties after firing.

1. A ceramic product produced from a mixture of natural and/or synthetic inorganic nonmetallic raw materials, at least one binder and optionally further additives, wherein the mixture comprises
a) at least 10% by weight (based on the weight of all solids of the mixture) of oxidic constituents,
b) from 0.05 to 2.7% by weight (based on the weight of all solids of the mixture) of at least one organic-based binder which has a plasticizing effect in the mixture and
c) from 3 to 10% by weight (based on the weight of all solids of the mixture) of a water-containing dispersion medium
and the ceramic product after use at temperatures above 600° C. contains less than 0.1% by weight (based on the total weight of the ceramic product) of carbon.

2. The ceramic product of claim 1, wherein the oxidic constituents and the nonoxidic constituents are present in a ratio of from 80:20 to 50:50.

3. The ceramic product of claim 1, wherein the oxidic constituents are selected from among Al₂O₃, MgO, MgAl₂O₄, CaO, ZrO₂, Cr₂O₃, CeO₂, Y₂O₂ and TiO₂ and natural and/or synthetic raw materials containing these.

4. The ceramic product of claim 1, wherein the nonoxidic constituents are selected from among SiC, Si₃N₄, BN and B₄C.

5. The ceramic product of claim 1, wherein the organic-based binder comprises a synthetically produced binder selected from the group consisting of phenolic resins, epoxy resins, furan resins, amino resins, alkyd resins, resorcinol resins, aqueous dispersions of novolaks, resols and/or epoxy resins, acrylate dispersions and polyurethane dispersions.

6. The ceramic product of claim 5, wherein the organic-based binder is an aqueous phenolic resin.

7. The ceramic product of claim 1, wherein the mixture contains a hardener as further additive.

8. The ceramic product of claim 7, wherein the hardener is selected from the group consisting of esters, acids and amines.

9. The ceramic product of claim 1, wherein the ceramic product is a shaped refractory body.

10. The ceramic product of claim 1, wherein the shaping of the product is effected during use.

11. (canceled)

12. A process for producing the ceramic product of claim 9 comprising:
a) homogenizing the mixture,
b) shaping of the mixture and drying and/or curing at above 15° C. and
c) optionally removing the mixture from the mold and further drying and/or curing at temperatures above 50° C.

13. The ceramic product of claim 1, wherein the organic-based binder comprises a naturally produced binder selected from the group consisting of sugar, glucose, polysaccharides, lignins and tannins.
